(19) United States
(12) Patent Application Publication
(10) Pub. No.: US 2016/0343031 A1
(43) Pub. Date: Nov. 24, 2016

(54) SEARCH APPLICATION WITH DONATION MECHANISM

(71) Applicant: Ilya Kandibur, Corona, CA (US)

(72) Inventor: Ilya Kandibur, Corona, CA (US)

(21) Appl. No.: 14/715,877

(22) Filed: May 19, 2015

(51) Int. Cl. G06Q 30/02; G07F 17/32

(52) U.S. Cl. CPC G06Q 30/0258; G06Q 30/0274; G06Q 30/0279; G07F 17/3255

(57) ABSTRACT

Improvements in a search application with a donation mechanism for donations for charities to be made when a person check in with a shop or restaurant. This eliminates a proactive effort from a user to donate. The user performs actions that they would normally perform when they dine, visit an establishment or search for products, services or dining. The user can receive a list of the donations based upon their continued shopping and purchases. A chip essentially has the equivalence of a particular monetary value. As an example a chip also earns a universal chip reward point for check-in & purchase. The chips provide rewards towards special offers at any participating shop or restaurant. If a user has a favorite shop or restaurant is not yet participating, then the user can “seed” the restaurant or business by request that the company joins into the search application.

### CROSS REFERENCE TO RELATED APPLICATIONS

This application is a continuation-in-part of applicant's co-pending application Ser. No. 62/005,404 filed May 30, 2014 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in an application. More particularly, the present application provides a user with a search tool where use of the search tool provides a donation for both the person searching and for the company paying for advertising so they are found in the search.

2. Description of Related Art Including Information Disclosed Under 37 CFR 1.97 and 1.98.

Most companies want to grow their business. The method used is by advertising where the company wants to locate additional, new or repeat business. One common method of advertising is with applications that are distributed for use on smart devices such as but not limited to smart phones, tablets, netbooks, desktop computers and laptop computers. All of these devices allow a person to electronically search for companies for products and or services. Many people further want to donate to a charity, but few are able to donate because of limited financial means.

There have been several people and or companies that have filed patents on advertising applications. There have also been several people and or companies that have filed patents that provide for donating to a charity, school or other beneficiary. A number of patents and or publications have been made to address these issues. Exemplary examples of publication that try to address this/these problem(s) are identified and discussed below.

U.S. Publication 2008/0281690 was published on Nov. 13, 2008, and U.S. Publication 2010/0004992 was published on Jan. 7, 2010, both for Terrence Patrick Tietzen et al discloses a Loyalty Engine for Dynamic Administration of Charity Donations for Automated Cause Marketing. These publications supports loyalty from the consumer and or the vendor with continued use of the business or service. It does not provide a mechanism for locating a new business where searching and finding a business provides benefit to a charity.

U.S. Publication 2010/0023365 was published on Jan. 28, 2010 to Thomas Anthony Cifelli discloses a Multi-Tiered Incentive Referral Compensation and Charitable Contribution database for Business Networking Websites Selling Goods or Services in Electronic Commerce. This publication uses a word-of-mouth and viral customer referral to spread advertising information. The referral is driven by a software database and includes an offering for charitable donations. While the database offers charitable donations the donations are now an inherent result from using the database.

U.S. Publication 2011/0295749 was published on Dec. 1, 2011 to Daniel Scalisi discloses a System and Methods for Fundraising Via Mobile Applications. In this publication a person can make a charitable donation from a mobile device. While it provides a method where a person can make a charitable donation from a phone the donation is not from a person using the phone to perform a search for a local business or service.

What is needed is a search engine that ensures that donations to charities are created when a person searches for a business and continues to use the business. The proposed search application with a donation mechanism provides the solution.

### BRIEF SUMMARY OF THE INVENTION

It is an object of the search application with a donation mechanism for donations for charities to be made when a person check in with a shop or restaurant. This eliminates a proactive effort from a user to donate. The user performs actions that they would normally perform when they dine, visit an establishment or search for products, services or dining. It just requires a person to be registered and to use the search application that provides the donation from the actions of the user.

It is an object of the search application with a donation mechanism for automated generation of donations. With enrollment, a user identifies the charity where donations will be made. From that point forward purchases and use will automatically result in donations to the designated charity. The user can receive a list of the donations based upon their continued shopping and purchases. The user can further designate donations to a number of charities. At any time, a report can be generated showing a statement with donations made based on user criteria.

It is still another object of the search application with a donation mechanism for the businesses participating to trade-in rewards points (chips) into the application in return for direct advertising and preferred listing in search results to users in the application. The only method of advertising to users is by donating, offering rewards to users, then trading in these rewards into the application for placement in search results and advertising. This creates a self-perpetuating system with a level playing field, where offering bigger donations and better rewards for users is the only way to increase advertising and placement for the business. Direct monetary payment in return for advertising and search placement is not accepted.

It is another object of the search application with a donation mechanism for the person or organization to earn universal reward chips to use towards participating shops or restaurant locations. These reward chips help fund further loyalty and discounts. The rewards are semi self-perpetuating to provide incentive to further utilize the search application and return to the places that participate in the donation process.

It is another object of the search application with a donation mechanism for the participating shops & restaurants to designate a chip amount to donate to a patron's charity of choice. A chip essentially has the equivalence of a particular monetary value. As an example a chip also earns a universal chip reward point for check-in & purchase. The chips provide rewards towards special offers at any participating shop or restaurant.

It is still another object of the search application with a donation mechanism for the application to assist in seeding. If a user has a favorite shop or restaurant is not yet participating, then the user can “seed” the restaurant or business by request that the restaurant, store or service joins and the user can earn extra bonus chip rewards when the company joins into the search application.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a flow chart for a user registering with the application.

FIG. 2 shows a flow chart for a business registering with the application.

FIG. 3 shows a diagram of the mobile massive donation reward exchange (MMDRE).

FIG. 4 shows how the application operates to generate donations to a charity.

FIG. 5 shows how the application operates to provide business incentives.

### DETAILED DESCRIPTION OF THE INVENTION

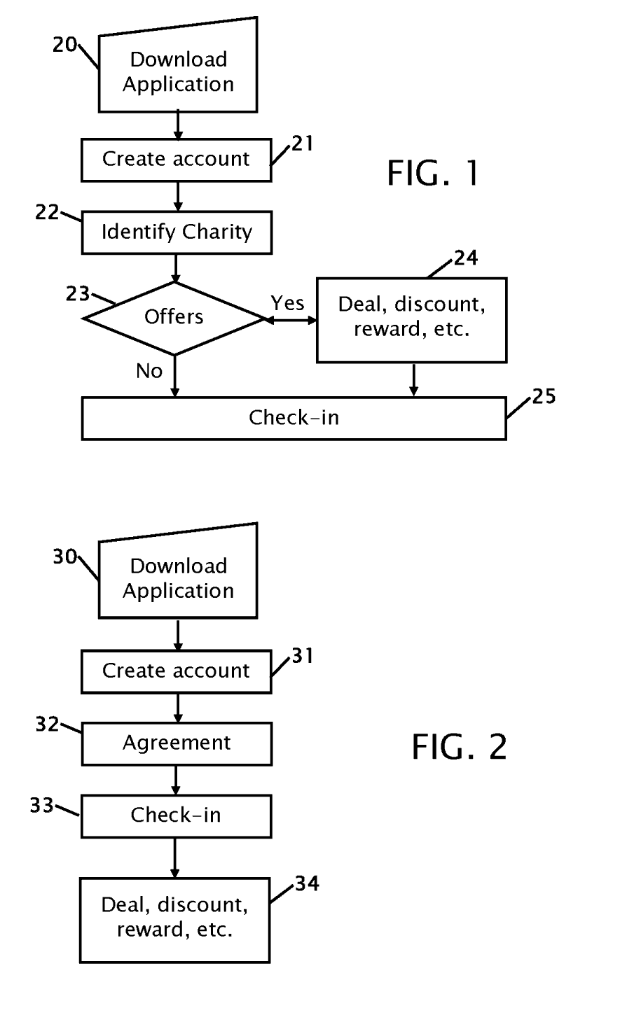

FIG. 1 shows a flow chart for a user registering with the application. To begin using the application, the user downloads an application 20. The application is a free to download and is used by “customers” of a business to “check in” to their location(s) when shopping. In the preferred embodiment the application is for a mobile device such as, but not limited to, a cellular phone or a computing table, but can also be a portable or desktop computer as well as a kiosk. While a mobile application may be described in this application, it should be understood that the application can operate on other platforms that are not limited to mobile devices or mobile applications.

During account creation 21, the “customer” chooses from a list of charities 22 they would like all donations to be contributed. This can be changed or altered in the future. While only a single charity can be designated the user can identify more than one charity or can switch between multiple charities. When more than one charity is designated the user will be able to select multiple charities, and every pre-determined time period (monthly), the full amount will be divided equally among the charities and automatically distributed. In fact, there will be a mechanism for allowing the user to assign a percent of total to distribute to their choices, based on their preference. The charities are preferably selected from a list of known charities. It is contemplated that the application can include a selection to allow for donations for a local or temporary event.

A participating business can offers 23 deals, discounts, rewards, or other incentives 24 to the “customers” for checking in using the application. The user can review the deal(s) discount(s), reward(s) etc. to determine if they would like to take advantage of the offer. These incentives are at the complete discretion of the business and not dictated by the application. The only requirement of the business is a minimum donation of a monetarily valued amount per “check in” 25. The “check-in” 25 by a customer can consist of a single or multiple transactions if done as a group of more than one person.

FIG. 2 shows a flow chart for a business registering with the application. To participate in the mobile app and be listed on a map, the business downloads the application 30, creates an account 31 and commits to paying a minimum donation per transaction or “check-in” to participate. The mobile app is free to download for the business, but cannot be participated in by the business until an account is created and a minimum donation per transaction is selected. The company can check-in 33 and create any offers 34, deals, discounts or rewards for using the application.

The server application keeps track of amount of transactions or “check ins” 25 at each business by “customers”. At a pre-determined time frame (monthly, etc.) an auto Invoice is generated by mobile application and emailed to the business. This Invoice is based on the amount of calculated “check-ins” for that time period. The invoice is sent to the business for payment. When a business pays the invoice 57, 100% of payment is transferred to a non-profit organization 52 created for the sole purpose of distributing these funds to charities selected by the “customers” playing the game. If a business does not pay the invoice the business is remove or suspended from receiving links from the application.

Each “customer” earns reward points (referred to as “chips” in this application) for checking-in 25 at a businesses. The customer further can also earns additional “chips” within the application for performing optional tasks such as posting the check-in 25 to social media, viewing an advertisement, checking-in 25 as a group with other “customers”, and other incentives offered by the mobile application at the time.

When business pay their respective invoice, 100% of payment is transferred 53 to a non-profit organization 56 created for the sole purpose of distributing these funds to charities. The charities are designated 22 by the “players” or “customers” using the mobile app, not by the business transferring the funds.

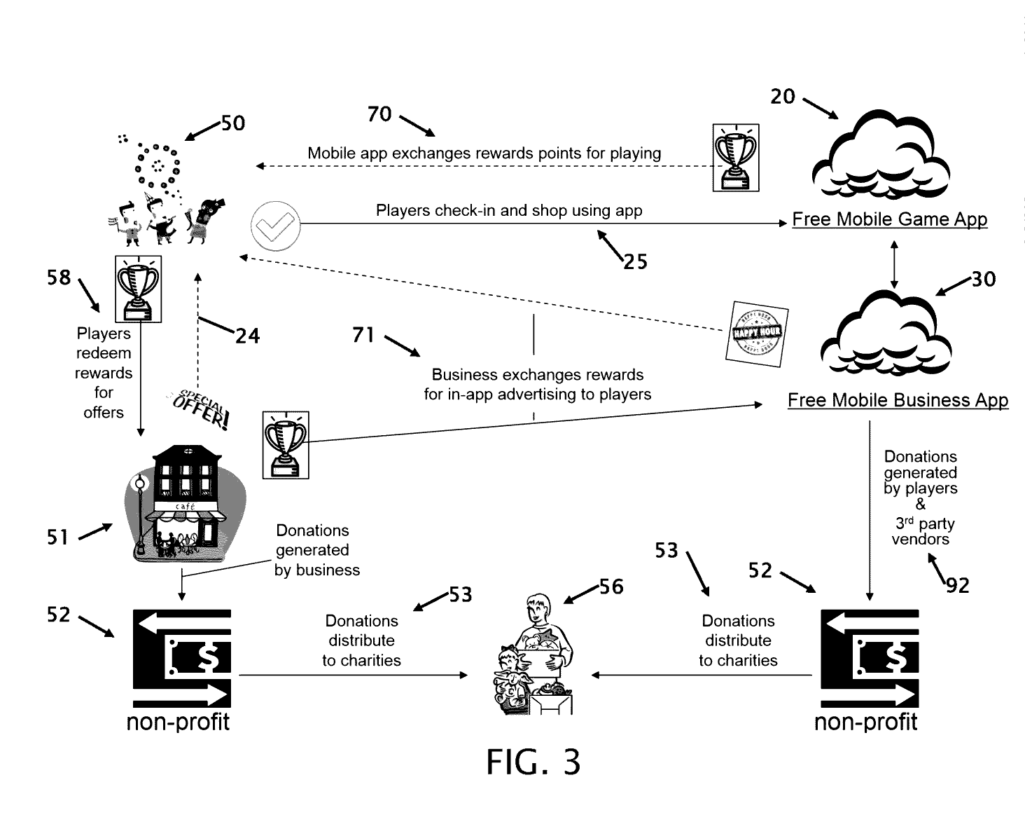

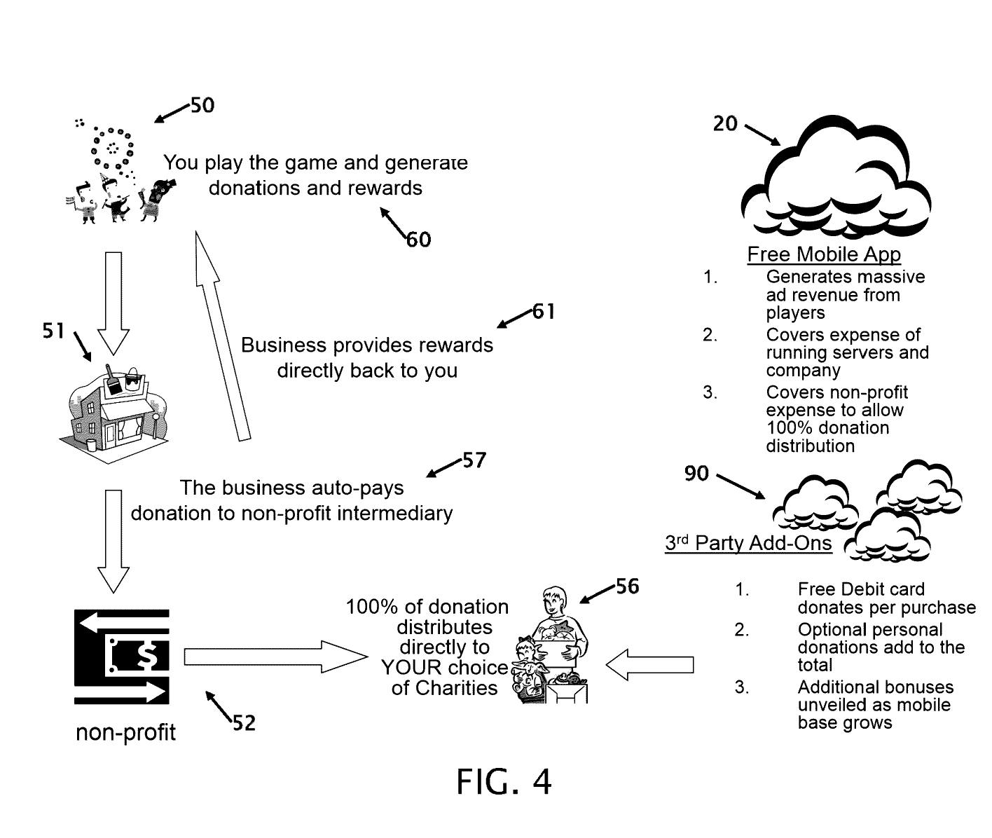

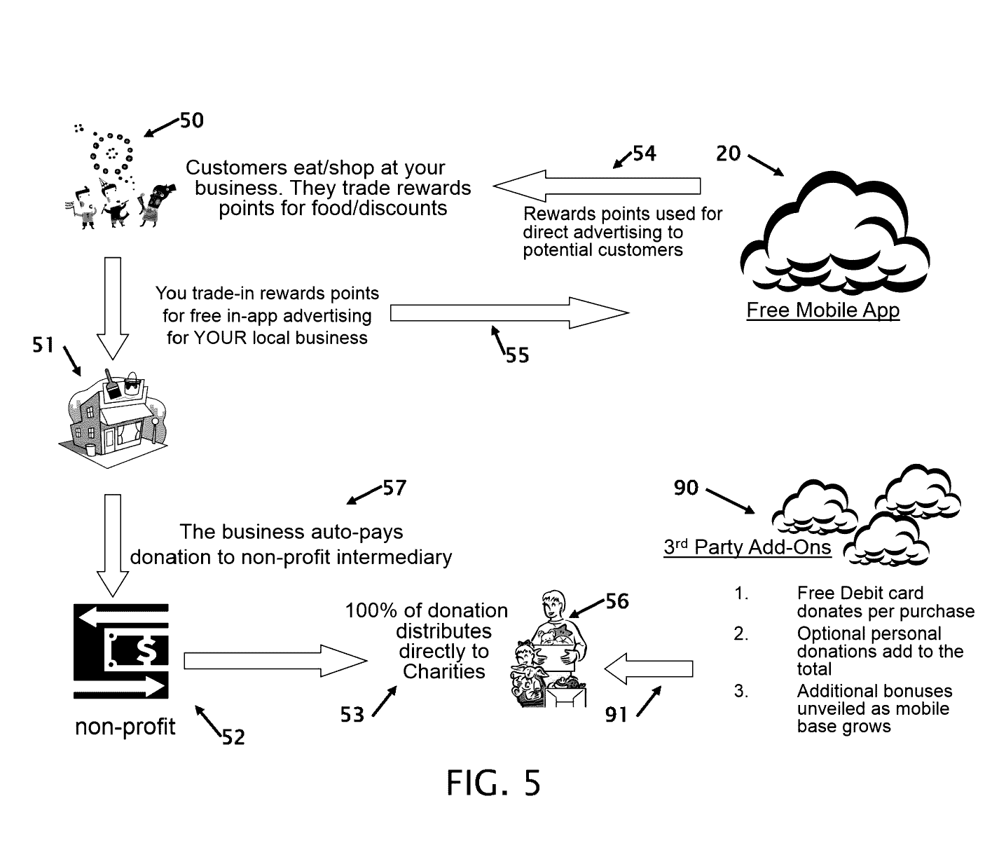

FIG. 3 shows a diagram of the mobile massive donation reward exchange (MMDRE), FIG. 4 shows how the application operates to generate 60 donations to a charity and FIG. 5 shows how the application operates to provide business incentives.

For every pre-determined donation given by the business 51, the business 51 also earns a specific amount of chips. Business has the choice to offer additional incentives to “customers” in return for trading in the “customer's” chips into the mobile application. Chips can be redeemed by the business within the mobile application in return for direct advertising 71 to “customers” using the application. The chips are gained by the business, both by donations given, and from “customers” when they redeem chips 55 for incentives, can be used within the mobile application to generate advertising 54. The advertising can consist of displaying their “ad” during “customer” searches within the app, but can be exchanged for other forms of advertising that without financial expense to the business. The business receives a featured listing for that specific search at the top of the search results, as well as being highlighted on a geographic map. Essentially, the more chips a business redeems within the application, the more direct advertising they are given or available to the business.

The incentive for the business 51 to donate 57 is to be shown on a local geographic map during searches and be seen by all “customers” within the app. The greater amount that is donated from the business 51 and/or from the earned chips from customers 50, the more chips the business earns toward advertising. The incentive for the business to offer additional rewards and incentives to customers, is to earn additional chips toward advertising beyond what is already earned based on their donations. The more chips they collect from “customers”, the more they can trade-in for in-app advertising to customers.

The incentive for the “customer” 50 to check-in 25 to participating stores is to generate donations for their favorite charities without financial impact to the customer 50. Additional incentive for the “customer” 50 to check-in 25 is to earn additional “chips” within the application, which can be redeemed for various deals and incentives offered by the business 61. The more they check-in 25 and perform additional tasks, the more chips they earn that can be redeemed at various businesses 51. Chips earned by users are Universal and can be used across all participating businesses, and are not locked into a specific location. However, the business can also offer incentives for repeat check-ins and loyalty, such as special offers that only unlock after a pre-determined amount of check-ins to their location. It is contemplated that both methods are valid.

The “chips” within the application have a value designated by the application, but have no monetary value outside of the application. The “chips” have value to the customer 50 based on what they can redeem 58 at a participating business 51 or can exchange 70 reward points for playing. The “chips” have value to the business 51 in what they redeem 71 within the application in return for direct advertising back to customers.

The mobile application generates revenue from banner ads and other forms of advertising that are visible to the user or customer when the user or customer checks-in 25 or is using the application. Donations distribute 53 to the non-profit 56 and are not passed through the mobile application in any way. The mobile application profits, from advertising, are used to pay for expenses incurred by the non-profit 52, to allow the non-profit 52 to pass through 100% of donations to charities 56. The only exception for passing 100% of the donations to the charities is for transaction fees incurred by the payment process between the business 51 and the non-profit 56. Transaction fees are subtracted from the total donation payment given. This transaction fee is determined by the service being used, for example to process credit or debit cards.

The application further provides a system for third party add-ons 90. The add-ons can include, but not be limited to free debit card donations per purchase, optional personal donations added 92 by players or other to the total and additional bonuses that are unveiled as the mobile base of customers grow.

Metrics can be provided to participating businesses, showing them the amount of individuals that checked into their location based on their advertising and listing in search results. This provides the business with direct feedback on the effectiveness of the advertising. The application maintains privacy and does not assign names, only numerical values. It provides a tool for the business to evaluate the effectiveness of their advertising. For example, out of the 500 users that saw your ad and featured listing in search results, 150 checked-in to that location.

Thus, specific embodiments of a search application with a donation mechanism have been disclosed. It should be apparent, however, to those skilled in the art that many more modifications besides those described are possible without departing from the inventive concepts herein. The inventive subject matter, therefore, is not to be restricted except in the spirit of the appended claims.

1. A search application with a donation mechanism comprising:
an application that is used by a user;
said application is also used by a company whereby said company offers a product or service that is used or consumed by said user;
said user selects at least one charity for contribution;
said application provides points for using said application, and
use of said application provides a donation from said company when said user searches said company.

2. The search application with a donation mechanism according to claim 1 further includes generation of reward points that are generated when said user checks-into said company.

3. The search application with a donation mechanism according to claim 1 wherein said company makes a donation to said at least one charity based upon said points.

4. The search application with a donation mechanism according to claim 1 wherein points are further generated by playing games.

5. The search application with a donation mechanism according to claim 1 wherein said donation to said charity is distributed automatically.

6. The search application with a donation mechanism according to claim 1 wherein said charity is selected from group of charities

7. The search application with a donation mechanism according to claim 1 wherein said charity is enterable from said user.

8. The search application with a donation mechanism according to claim 1 wherein said charity is identified by said company.

9. The search application with a donation mechanism according to claim 1 wherein said application is downloaded to a computer, mobile computing device or a cellular device.

10. The search application with a donation mechanism according to claim 1 further includes a reporting system that identifies a contribution to said at least one charity.

11. The search application with a donation mechanism according to claim 1 further includes a reporting system that identifies a contribution from said user.

12. The search application with a donation mechanism according to claim 1 further includes a reporting system that identifies a contribution from said user.

13. The search application with a donation mechanism according to claim 1 wherein said user is also able to add additional donation to said at least one charity.

14. The search application with a donation mechanism according to claim 2 wherein said reward points are redeemable for advertising.

15. The search application with a donation mechanism according to claim 2 wherein said reward points are redeemable for preferred listing of said company.

16. The search application with a donation mechanism according to claim 1 wherein said reward points equate to a monetary value that is only redeemable for said monetary value to said at least one charity.

17. The search application with a donation mechanism according to claim 2 wherein if said user frequents an establishment that is not participating in said donation mechanism, said user can seed said establishment.

18. The search application with a donation mechanism according to claim 17 wherein when said establishment joins said donation mechanism said user receives reward points.

19. The search application with a donation mechanism according to claim 1 wherein said user checks in at said company said company receives points.

20. The search application with a donation mechanism according to claim 1 wherein said user checks in at said company said user receives points.
